(19) United States
(12) Patent Application Publication
(10) Pub. No.: US 2009/0171685 A1
(43) Pub. Date: Jul. 2, 2009

(54) Approval Repository

(75) Inventors: Ruchika A. Arun, New Delhi (IN); Manik A. Ahluwalia, New Delhi (IN); Rupali P. Pal, Delhi (IN); Vikram B. Bansal, Faridabad Haryana (IN)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: AMERICAN EXPRESS TRAVEL RELATED SERVICES COMPANY, INC., New York, NY (US)

(21) Appl. No.: 12/038,384

(22) Filed: Feb. 27, 2008

(30) Foreign Application Priority Data
Dec. 26, 2007 (IN) 3104/CHE/2007

(51) Int. Cl. G06Q 99/00

(52) U.S. Cl. 705/1

(57) ABSTRACT

A method and system are used to seek required approvals at various steps of a reconciliation process. A framework is created by which an end user can request for some of the key administrative maintenances done on a reconciliation application, along with an approval hierarchy being followed. A complete audit trail is maintained for what entity requested, approved and executed the request.

### CROSS REFERENCE TO RELATED APPLICATIONS

This application claims benefit under 35 U.S.C. §119(a)-(d) to Indian Provisional Patent Application No. 3104/CHE/2007, filed Dec. 26, 2007, which is incorporated by reference herein in its entirety.

### BACKGROUND

1. Field of the Invention

This invention generally relates to a system and method for approval repositories.

2. Related Art

Currently, some reconciliation tools are not governed by any approval or control processes. However, there can be an imperative requirement to have approvals in place to execute various setup activities that are requested by users. Further, there may be a need to track requests, decisions, and entities involved in making the decisions.

There is a need for a system and method that use an approval process to analyze and determine approvals for user requests, while also tracking information regarding approval decisions.

### SUMMARY

In an embodiment, the present invention provides a method comprising the following steps: (a) determining whether to approve a user request through analyzing the user request and any related information during a first approval decision; (b) alerting a user when step (a) is unsuccessful; (c) when step (a) is successful, determining whether to approve the user request by analyzing the user request and the related information during a second approval decision; and (d) alerting a user whether the second approval decision is successful or unsuccessful.

In another embodiment, the present invention provides a system comprising an approval device. The approval device is coupled to a user device. The user device is coupled to a storage device and configured to generate a user request and associate any respective information from the storage device with the user request. The approval device is configured to receive the user request and any of the respective information. The approval device comprises a first approval module, one or more additional approval modules, and a controller. The first approval module is configured to analyze the user request and the respective information to generate a first result signal. The one or more additional approval modules are configured to analyze the user request and the respective information to generate corresponding additional result signals. The controller is configured to receive the result signals and to generate an alert signal and, in one example, an audit signal therefrom, such that the alert signal is transmitted to the user device and the audit signal is transmitted to an audit storage device.

In a further embodiment, the present invention provides a computer program product comprising a computer useable medium having a computer program logic recorded thereon for controlling at least one processor, the computer program logic comprising computer program code devices that perform operations similar to the devices in the above embodiments.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings. The left-most digit of a reference number may identify the drawing in which the reference number first appears. Similar reference numbers may indicate similar elements.

FIG. 1 shows a system.

FIG. 2 shows a flowchart depicting a method.

FIG. 3 is a block diagram of an exemplary computer system for use with the system and method of this invention.

### DESCRIPTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Persons skilled in the relevant arts will understand the breadth of the terms used herein and that the exemplary descriptions provided are not intended to be limiting of the generally understood meanings attributed to the foregoing terms.

The embodiments of the present invention relate to seeking required approvals at various steps of a reconciliation process. A framework is created by which an end user can request for some of the key administrative maintenances done on a reconciliation application, along with an approval hierarchy being followed. A complete audit trail is maintained for what entity requested, approved and executed the request.

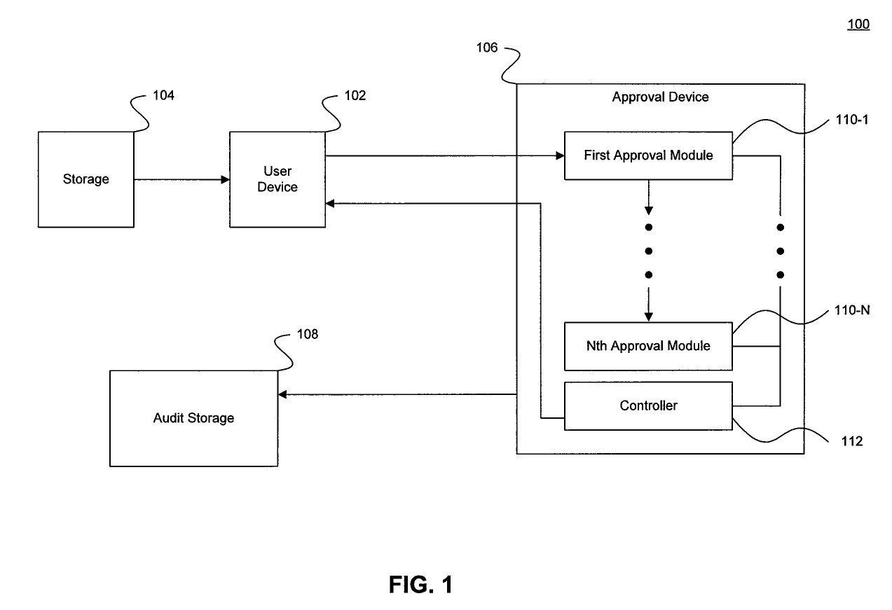

FIG. 1 shows a system 100. System 100 includes a user device 102 (e.g., server, computer, computer system, handheld device, etc), a storage 104 (e.g., a database, memory, etc.), an approval device 106, and, optionally, an audit storage 108 (e.g., a database, memory, etc.). Approval device 106 comprises a first approval module 110-1, one or more additional approval modules 110-N, and a controller 112.

Devices 102-112 can be a coupled together through a wired or wireless telecommunications or data network, such as a cellular network, a hard-wired or optical telephone network, a satellite network, an Internet, Intranet, or Extranet network, or other similar networks, as would be apparent to a skilled artisan upon reading and understanding this description.

Approval modules 110 and controller 112 (e.g., a processor) can be one or more microprocessors or operating systems with associated applications (software applications), such as one or more computer systems. The functions performed by approval modules 110 and processor/controller 112 can be performed by hardware, software, firmware, or a combination thereof.

In operation, user device 102 can generate a user request. For example, a request can be for changes in access and use of various accounts by a user. First determination module 110-1 determines whether to approve the user request through analyzing the user request and any related information, possibly from storage 104 during a first approval decision. A user via user device 102 is alerted when the determination is unsuccessful using controller 112. When the determination is successful, a subsequent determination module 110-N determines whether to approve the user request through analyzing the user request and the related information during a second approval decision. The user is then alerted, via user device 102, whether the second approval decision is successful or unsuccessful using controller 112.

In one example, the user request is implemented when the second determination is successful.

In another example, information relating to the first and second approval decisions is stored in audit storage 108.

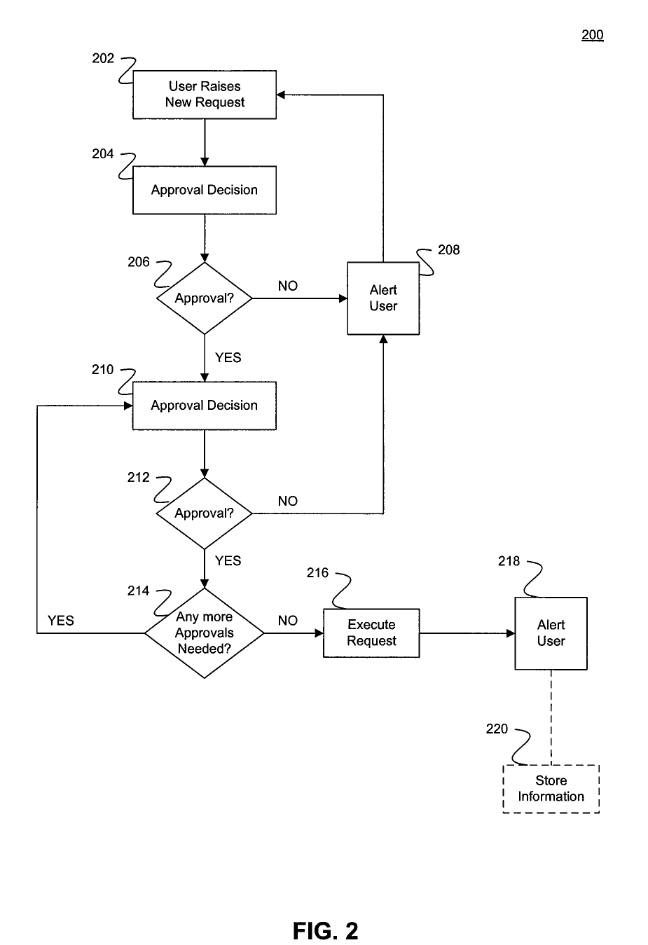

FIG. 2 is a flowchart depicting a method 200. For example, method 200 can be performed using one or more of the systems discussed above and below. Method 200 can be an approval process.

In step 202, a user raises a new request. In step 204, a first approval decision is made. In step 206, a determination is made whether the new request is approved. If the new request is not approved, the user is alerted at step 208. If the new request is approved, a second approval decision is made at step 210. In step 212, a determination is made whether the new request is approved during the second approval decision. If not approved during the second approval decision, the user is alerted at step 208. If approved during the second approval decision, a determination is made whether additional approvals are needed. If yes, the process returns to step 210. If no, the new request is executed or implemented at step 216, and the user is alerted of this decision at step 218. Optionally, at step 220 all or some of the information generated during steps 202-218 is stored. Such information cam later be retrieved, for example, for auditing purposes.

### EXAMPLE IMPLEMENTATIONS

The present invention (i.e., system 100, method 200, or any part(s) or function(s) thereof) may be implemented using hardware, software or a combination thereof and may be implemented in one or more computer systems or other processing systems. However, the manipulations performed by the present invention were often referred to in terms, such as receiving or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

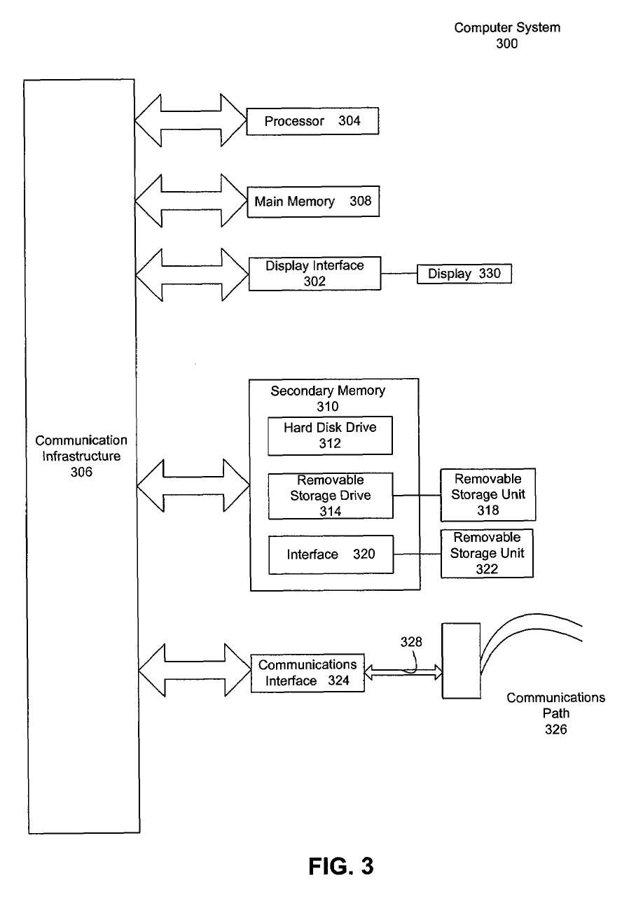

In fact, in one embodiment, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross over bar, or network). Various software embodiments are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

### CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention). Thus, the present invention should not be limited by any of the above described exemplary embodiments, but should be defined only in accordance with the following claims and their equivalents.

In addition, it should be understood that the figures and/or screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method, comprising:
(a) determining whether to approve a user request through analyzing the user request and any related information during a first approval decision;
(b) alerting a user when step (a) is unsuccessful;
(c) when step (a) is successful, determining whether to approve the user request through analyzing the user request and the related information during a second approval decision; and
(d) alerting a user whether the second approval decision is successful or unsuccessful.

2. The method of claim 1, further comprising:
(e) implementing the user request when step (c) is successful.

3. The method of claim 1, further comprising:
(e) storing information corresponding to steps (a) and (c).

4. The method of claim 1, further comprising, before step (d):
determining whether additional approval decisions are required; and
when the additional approval decisions are required, determining whether to approve the user request through analyzing the user request and the related information during one or more additional approval decisions.

5. A computer-readable medium containing instructions for controlling at least one processor of a host computer by a method comprising:
(a) determining whether to approve a user request through analyzing the user request and any related information during a first approval decision;
(b) alerting a user when step (a) is unsuccessful;
(c) when step (a) is successful, determining whether to approve the user request through analyzing the user request and the related information during a second approval decision; and
(d) alerting a user whether the second approval decision is successful or unsuccessful.

6. The method of claim 5, further comprising:
(e) implementing the user request when step (c) is successful.

7. The method of claim 5, further comprising:
(e) storing information corresponding to steps (a) and (c).

8. The method of claim 5, further comprising, before step (d):
determining whether additional approval decisions are required; and
when the additional approval decisions are required, determining whether to approve the user request through analyzing the user request and the related information during one or more additional approval decisions.

9. A system, comprising:
an approval device coupled to a user device, the user device being coupled to a storage device and configured to generate a user request and associate any respective information from the storage device with the user request, the approval device being configured to receive the user request and any of the respective information, the approval device comprising,
a first approval module configured to analyze the user request and the respective information to generate a first result signal;
one or more additional approval modules configured to analyze the user request and the respective information to generate corresponding additional result signals;
a controller configured to receive the result signals and to generate an alert signal and an audit signal therefrom, such that the alert signal is transmitted to the user device and the audit signal is transmitted to an audit storage device.

10. The system of claim 9, wherein the controller is configured to generate an approval signal or a denial signal as the alert signal.

11. A computer program product comprising a computer useable medium including control logic stored therein, comprising:
first control logic means for enabling the computer to determine whether to approve a user request through analyzing the user request and any related information during a first approval decision;
second control logic means for enabling the computer to alert a user when the determining is unsuccessful;
third control logic means for enabling the computer to determine whether to approve the user request through analyzing the user request and the related information during a second approval decision when the determining is successful; and
fourth control logic means for enabling the computer to alerting a user whether the second approval decision is successful or unsuccessful.
